(19) United States
(12) Patent Application Publication
(10) Pub. No.: US 2026/0072261 A1
(43) Pub. Date: Mar. 12, 2026

(54) TRANSMITTED LIGHT MICROSCOPY SYSTEMS AND METHODS OF USE

(71) Applicant: RareCyte, Inc., Seattle, WA (US)

(72) Inventors: Rider CLAUSS, Seattle, WA (US); Jeremy Ryan COOPER, North Bend, WA (US)

(21) Appl. No.: 18/827,107

(22) Filed: Sep. 6, 2024

(51) Int. Cl. G02B 21/00

(52) U.S. Cl. CPC G02B 21/0032; G02B 21/0036

(57) ABSTRACT

Described herein are imaging systems and methods for the analysis of biological samples, including transmitted light microscopy systems that may overcome certain limitations of optical train design, size, and structure. More particularly described are transmitted light microscopy systems having a tapered light pipe that may be used to modify and optimize the cone angle of an illumination light to result in a numerical aperture (NA) that matches the NA of an objective lens.

### CROSS REFERENCE TO RELATED APPLICATIONS

None.

### FIELD OF THE INVENTION

This disclosure relates generally to imaging systems and methods for the analysis of biological samples. More particularly, this disclosure relates to microscopes and imaging systems, including transmitted light microscopy systems and methods of use, which may overcome the limitations of optical train design, size, and structure. Furthermore, this disclosure relates to transmitted light microscopy systems having a tapered light pipe that may be used to optimize the cone angle of the illumination light to match the numerical aperture (NA) of an objective lens.

### BACKGROUND

Transmitted light microscopy is a powerful technology that is used to detect and image cellular structures and components. The resolution of an optical microscopic imaging system, or its ability to distinguish details of a sample, is dependent on multiple factors including the characteristics of the light being used to illuminate the sample, the optical train components, and the structure of the system.

In transmitted light microscopy systems, a lens or a condenser is often used to collect light from a light source and then output that light to illuminate a sample. An objective lens is generally located on the opposite side of the sample plane and positioned to collect the light that passes through the sample. In some transmitted light microscopy systems, the lens or condenser used to gather the light from a light source might be bulky and include several optical elements that, because of the structure and design of the system, can be challenging to position close enough to the sample without interfering with the operation of the system.

Furthermore, in certain systems used for transmission light microscopy there may be structural design elements, such size limitations or sample handling requirements, which make it difficult to provide light to a sample with an optimal cone angle for a chosen objective lens. The numerical aperture (NA) is commonly used in microscopy to describe the acceptance cone of an objective lens. The NA is a measure of the objective's ability to gather light and to resolve fine specimen detail while working at a fixed sample distance. Higher values of NA allow increasingly oblique rays to enter the objective front lens, producing a more highly resolved image. To maximize the resolution of an imaging system, the incident angles, or cone angle, of the sample illuminating light can be optimized to match the NA of the objective lens being used. Therefore, there is a need for microscope imaging systems that can properly illuminate a sample while overcoming system physical design constraints and while optimizing the cone angle of the sample illumination light to match the NA of an objective lens.

### SUMMARY

Disclosed are novel transmitted light microscopy systems and methods of use. The disclosed embodiments may include a transmitted light microscopy system including a light source and a tapered light pipe to receive the light from the light source and to output the light and illuminate a sample. A tapered light pipe as disclosed herein may have a large end and a small end, the large end having a larger surface area than the small end and either the large end or the small end may be positioned to receive the light from the light source. In certain embodiments, the disclosed system may include one or more lens assemblies, to collect the light from the light source and output the light towards the tapered light pipe.

Some embodiments of the disclosed systems may include a substrate configured to support the sample. Such embodiments may include a mechanism to move a substrate holder, the substrate, and the sample to be illuminated by the light output from the tapered light pipe, and one or more objective lenses to receive light passing through the sample. The light output from the tapered light pipe may have a cone angle that results in an NA that substantially matches the NA of an objective lens.

In some embodiments, when the large end of the tapered light pipe is positioned to receive the light from the light source, the cone angle of the output light from the small end is increased compared to the cone angle of the light received by the tapered light pipe. In other embodiments, when the small end of the tapered light pipe is positioned to receive the light from the light source, a cone angle of the output light from the large end is decreased compared to the cone angle of the light received by the tapered light pipe. In certain embodiments, the systems disclosed herein may include a mechanism for positioning either the large end or the small end of the tapered light pipe to receive the light from the light source. In further embodiments, the systems disclosed herein may include a mechanism to move the tapered light pipe along an optical axis. In certain such embodiments, the mechanism may include a cam and a cam guide. In some such embodiments, when the large end of the tapered light pipe is positioned to receive the light from the light source, the small end of tapered light pipe may be positioned closer to the sample than when the small end of the tapered light pipe is positioned to receive the light from the light source. In alternative embodiments, the systems disclosed herein may include a spring to retract the tapered light pipe. In other embodiments, the systems disclosed herein may include a light blocker to limit light from entering the objective lens.

### BRIEF DESCRIPTION OF THE DRAWINGS

The subject matter of the present disclosure will be described in even greater detail herein based on the exemplary figures. All features described and/or illustrated herein can be used alone or joined in different combinations. The features and advantages of various embodiments will become apparent by reading the following detailed description with reference to the attached drawings, which illustrate the following:

FIG. 1 shows a view of an embodiment of a transmitted light microscopy system having a tapered light pipe.

FIG. 2 shows a perspective view of an embodiment of a tapered light pipe.

FIG. 3A is a perspective view of an embodiment of a transmitted light microscopy system with a tapered light pipe aligned with the optical axis in a selected orientation.

FIG. 3B is a drawing showing a close-up perspective view of the increased cone angle of the output light from the small end of the tapered light pipe from FIG. 3A.

FIG. 4A is a drawing showing a perspective view of the system in FIG. 3A with the tapered light pipe aligned with the optical axis in an alternate orientation.

FIG. 4B is a drawing showing a close-up perspective view of the decreased cone angle of the output light from the large end of the tapered light pipe from FIG. 4A.

FIG. 5 is a drawing showing a perspective view of an embodiment of a transmitted light microscopy system with the tapered light pipe positioned to be out of alignment with the optical axis.

FIG. 6 is a flowchart showing an embodiment of a method of scanning and imaging a sample with a transmitted light microscope.

### DETAILED DESCRIPTION

This disclosure relates to microscope imaging systems and methods of microscopic image processing and analysis. Furthermore, embodiments of this disclosure describe systems and devices for use with transmitted light microscopy. Generally, a transmitted light microscope system uses light from a light source that is collected by a lens or a condenser and then output to illuminate a sample and then emitted by the sample and into an objective lens which focuses and magnifies the image for viewing by a user or for capture by camera. In such systems, the condenser, sample holder, objective lenses, and other optical elements can occupy a substantial amount of space in the optical path. However, some transmitted light microscopes may have physical design constraints that can prevent traditional optical elements from being placed as needed to properly image the sample. For example, a sample slide holder or sample handling mechanism may not allow a bulky condenser to be positioned near the sample without the threat of damage to the sample or the system. The systems, devices, and methods disclosed herein may be useful for overcoming the physical design constraints of certain systems while optimizing the image resolution of objective lenses used for sample scanning and imaging during transmitted light microscopy.

The embodiments of the transmitted microscopy systems and methods disclosed herein may be used with most microscope techniques including, for example, brightfield, darkfield, phase, and differential interference contrast optics. Other transmitted light techniques that may be useful with the systems and methods described herein include Hoffman modulation, Varel optics, and polarization optics. Furthermore, the transmitted microscopy systems disclosed herein may be used with other imaging and analysis systems, such as immunofluorescence microscopy.

Certain embodiments of the disclosure may include light guides, waveguides, or light pipes that may be used to collect or receive light from a light source and output the light along a light path, or optical axis, onto a sample and into an objective lens. The light pipe may be made from glass, UV fused silica, plastics, polymers, crystals, or other materials with suitable optical clarity and refractive index. Light pipes according to the disclosure may be rigid, flexible, curved, or straight, and have, for example, a polygonal, rectangular, ovoid, circular or other shaped cross section. Certain embodiments of light pipes may have an input end, input face, or input aperture, with a different shape or cross section shape than the output end, output face, or output aperture. As used herein, the input end of a tapered light pipe may be configured or positioned to receive an input light from a light source. As used herein, the output end of a tapered light pipe may be configured or positioned to output light from the tapered light pipe. For example, a tapered light pipe may have a square input end and a circular output end. In some embodiments, the input end and the output end of the tapered light pipe may be parallel to each other. In other embodiments, the input end and the output end may not be parallel to each other. Embodiments of light pipes described herein use internal reflection to channel the light from the input end to the output end. In such embodiments, light pipes may utilize internal reflection to homogenize non-uniform light sources. In certain embodiments, the length of the light pipe may be adjusted to affect the uniformity of the output light.

As disclosed herein, embodiments of microscope imaging systems may include tapered light pipes with input and output ends, faces, or apertures, that have different surface areas. In some embodiments, the tapered light pipes may be configured with input and output ends that differ in surface area or size and have a magnification factor from approximately 1.1× to 10.0×. For example, a tapered light pipe may have a magnification factor of approximately 1.1×, 1.2×, 1.3×, 1.4×, 1.5×, 1.6×, 1.7×, 1.8×, 1.9×, 2.0×, 2.1×, 2.2×, 2.3×, 2.4×, 2.5×, 2.6×, 2.7×, 2.8×, 2.9×, 3.0×, 3.1×, 3.2×, 3.3×, 3.4×, 3.5×, 3.6×, 3.7×, 3.8×, 3.9×, 4.0×, 4.1×, 4.2×, 4.3×, 4.4×, 4.5×, 4.6×, 4.7×, 4.8×, 4.9×, 5.0×, 6.0×, 7.0×, 8.0×, 9.0×, or 10.0× or higher.

With input and output ends of different sizes, and the resulting taper between the ends, a tapered light pipe can be used to receive light from a light source having a certain cone angle and then output light onto a sample having a different cone angle (the cone angle measured from the optical axis). The output light may then pass through the sample and exit the sample with the same, or substantially the same, cone angle as the light output from the tapered light pipe, which light may then be received by an objective lens. The dimensions of the tapered light pipe can be used to modify and optimize the cone angle of the output light to result in an NA that substantially matches the NA of a particular objective lens. For example, when light enters the tapered light pipe at the smaller end and then exits from the larger end, the divergence of the cone angle of the output light is reduced proportional to the magnification factor of the tapered light pipe. Alternatively, when light enters the light pipe at the larger end and then exits from the smaller end, the divergence of the cone angle of the output light is increased proportional to the magnification factor of the tapered light pipe. In other words, the cone angle of the light output from a tapered light pipe may be increased or decreased relative to the cone angle of the received light proportionally to the magnification factor of the light pipe. In this way, the output light cone angle may be selected and optimized for the NA of an objective lens.

For certain embodiments of systems disclosed herein, the optimization of the cone angle of the light output from a tapered light pipe for use with a selected objective lens may contribute to the optical resolution of the system. In some such embodiments, for the maximum system resolution to be realized, the cone angle of the light output from a tapered light pipe may match, or substantially match, the NA of at least one objective lens.

NA is a value is given by the expression:

$$NA = η \cdot sin ( {θ}_{max} )$$

where θₘₐₓ equals one-half of the angular aperture of the maximum angle of image-forming light rays that the objective lens can capture, and η is the refractive index of the medium used between the objective and the sample (e.g., η=1 for air; η=1.51 for oil or glass). As such, the NA depends on the θₘₐₓ of the maximum cone angle of light that can enter or exit the lens and the ambient index of refraction. As used herein, a cone angle of the output light from a tapered light pipe that matches or fills, or substantially matches or substantially fills, the NA of an objective lens is a cone angle of output light that results in an NA that is approximately 80%, or greater of the NA of the objective lens. For example, a cone angle that results in an NA that is approximately 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5% or 100% of the NA of the objective lens.

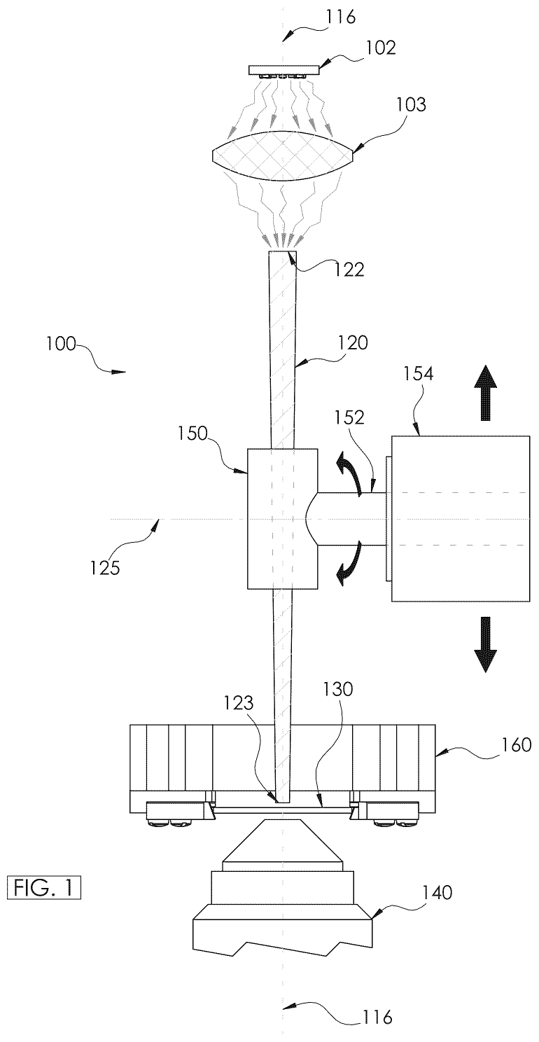

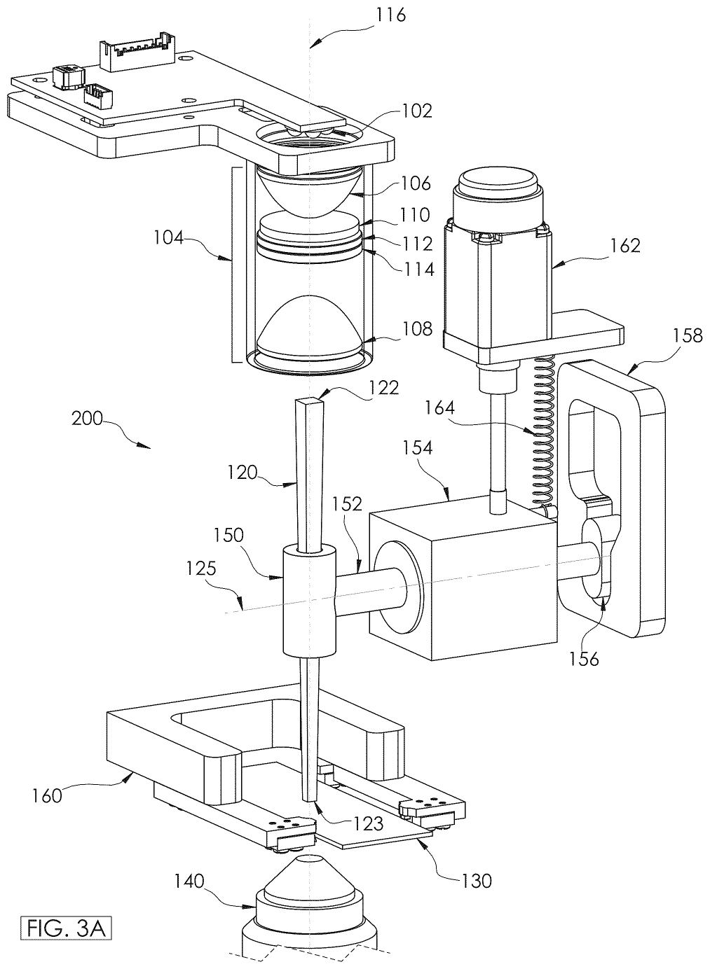

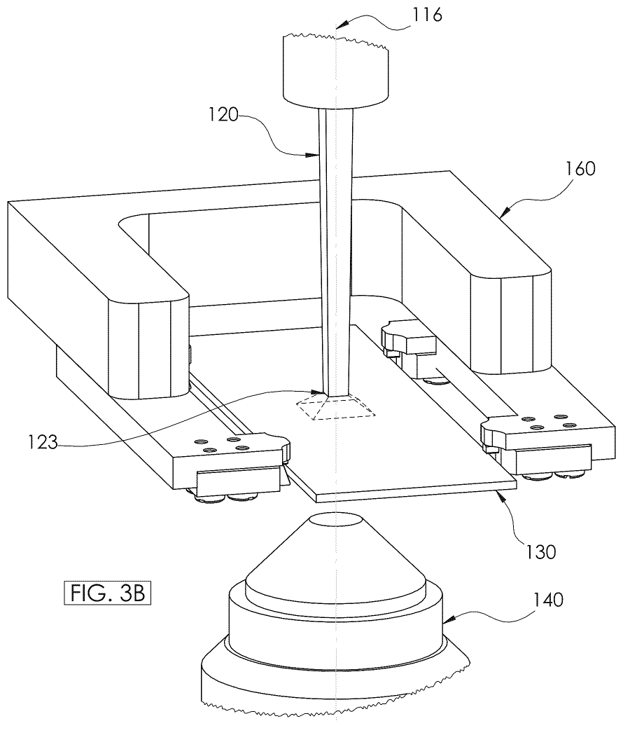

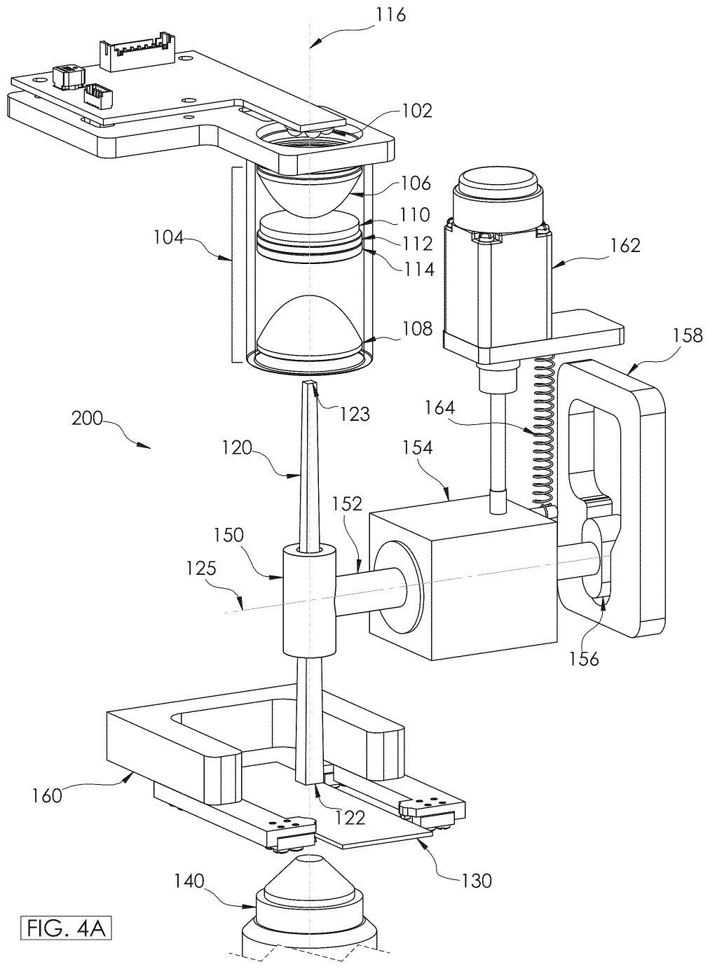

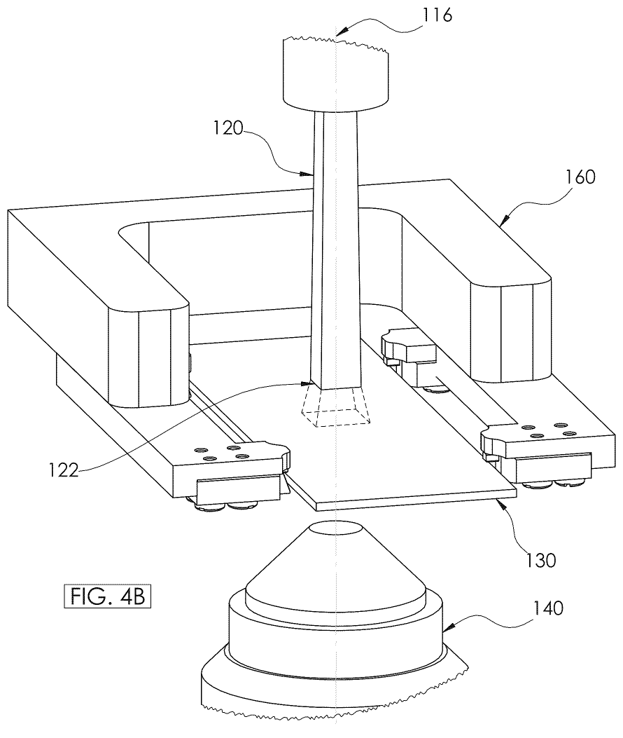

FIG. 1 shows an embodiment of a transmitted light microscopy system 100. The transmitted light microscopy system 100 may include a light source 102 and, optionally, a lens 103. In other embodiments, such as those shown in FIGS. 3A and 4A, the transmitted light microscopy system 200 may optionally include a lens assembly 104. The light source 102 may be an LED, a halogen lamp, an incandescent lamp, an arc lamp, or other suitable light source or illuminator. The lens assembly 104 may be constructed with one or more lenses, such as condenser lens 106 and condenser lens 108. In certain embodiments, the lens assembly 104 may include one or more of a bandpass filter 110, a diffuser 112, and an aperture 114. The lens 103 or the lens assembly 104 may be configured to collect the light from the light source 102 and output the light along the optical axis 116 of the transmitted light microscopy system, such as light microscopy system 100.

With reference to FIG. 1, the lens 103 may collect light from the light source 102. For some embodiments, certain optical elements, such as the lens 103, may be too large to be properly positioned near the substrate 130 during use of the substrate holder 160 and the objective lens 140. To overcome this limitation, a tapered light pipe 120 may be used to receive light from the light source 102 and to illuminate a sample supported by the substrate 130 without interfering with the operation of the substrate holder 160 or objective lens 140. In certain embodiments, a tapered light pipe 120 may be used to direct light from the lens 103 or the lens assembly 104 and towards the substrate 130 without interfering with the operation of the substrate holder 160 or objective lens 140.

The tapered light pipe 120 may be configured to receive light from the light source 102 directly, or from the lens 103 or the lens assembly 104, and then output light having a range of incident angles making up a cone angle, which may be used to illuminate a sample supported by substrate 130. In certain such embodiments, transmitted light microscopy system 100 or transmitted light microscopy system 200 may include one or more mechanisms configured to move the substrate holder 160 to position the sample to be illuminated by the light output from the tapered light pipe 120. After passing through the sample, the sample illuminating light may enter an objective lens 140 with approximately the same cone angle as when it was output from the tapered light pipe 120.

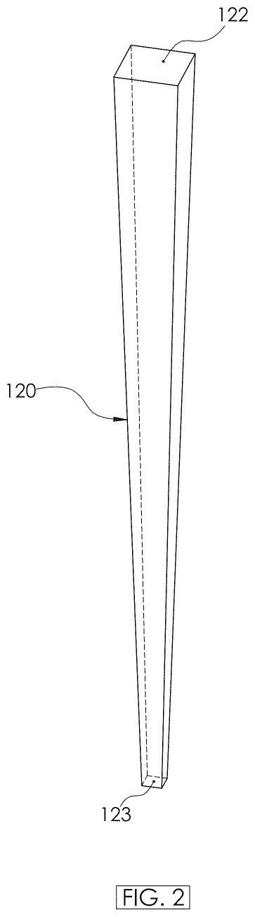

As shown in FIG. 2, embodiments of the tapered light pipe 120 may include a large end 122 having a face with a larger surface area from which the sides of the tapered light pipe 120 taper down to the face of the small end 123, having a smaller surface area. In the context of embodiments of the current disclosure, the terms “large”, “larger”, “small”, and “smaller” relate to the relative size of the referenced elements, i.e., the relative surface area of the ends of the light pipe.

The surface areas of the large end 122 and the small end 123 of the tapered light pipe 120 may be any surface area to produce the desired magnification factor and to optimize the cone angle of the output light. For example, the surface area of the small end 123 may be approximately 2 mm² and the surface area of the large end 122 may be approximately 4 mm² (resulting in a 2× magnification factor). In other embodiments, the surface area of the small end 123 may be approximately 2.5 mm² and the surface area of the large end 122 may be approximately 5 mm², the surface area of the small end 123 may be approximately 3 mm² and the surface area of the large end 122 may be approximately 6 mm², the surface area of the small end 123 may be approximately 4 mm² and the surface area of the large end 122 may be approximately 8 mm², or the surface area of the small end 123 may be approximately 5 mm² and the surface area of the large end 122 may be approximately 10 mm², etc. The tapered light pipe 120 embodied in FIG. 2 demonstrates a rectangular cross section, but other embodiments may have a circular, non-circular (e.g., oval or ovoid), or other polygonal cross section.

The length of the tapered light pipe 120 may be selected for the best fit in a transmitted light microscopy system. For example, the tapered light pipe 120 may be between 10 mm and 300 mm, such as approximately 10 mm, 20 mm, 30 mm, 40 mm, 50 mm, 60 mm, 70 mm, 80 mm, 90 mm, 100 mm, 110 mm, 120 mm, 150 mm, 200 mm, 300 mm, or other shorter or longer selected lengths.

As shown in FIG. 1, a transmitted light microscopy system 100 may include a mechanism configured to rotate the tapered light pipe 120 around a rotation axis 125. The mechanism may also be configured to position the tapered light pipe 120 along the optical axis 116 so that tapered light pipe 120 can receive light from the light source 102 directly, or from the lens 103, and then output that light to illuminate a sample. In certain embodiments, the rotation axis 125 may be perpendicular to the optical axis 116. With reference to embodiments shown in FIGS. 1, 3A, 4A, and 5, the tapered light pipe 120 may be held by a bracket or clamp, such as light pipe support 150, which can be configured to support the tapered light pipe 120 approximately perpendicular to the rotation axis 125. The light pipe support 150 may be attached to a rotation shaft 152 configured to rotate, as shown by the circular arrows in FIG. 1, the light pipe support 150 and the tapered light pipe 120 to any position on the rotation axis 125, including a position aligned with the optical axis 116, wherein either of the large end 122 or the small end 123 is positioned to receive light from the light source 102, lens 103, or the lens assembly 104. In such embodiments, the rotation shaft 152 may be supported by a bearing block 154. The bearing block 154, as described herein, may include a structure to house a bearing for supporting the rotation shaft 152. In certain such embodiments, the bearing block 154 may be moved (e.g., vertically according to the arrows in FIG. 1) to position the light pipe support 150 and the tapered light pipe 120 to a desired position along the optical axis 116. In some embodiments, the tapered light pipe 120 is positioned as desired by rotating the rotation shaft 152 and the light pipe support 150 before moving towards the surface of the substrate 130. In other embodiments, the tapered light pipe 120 is positioned by rotating the rotation shaft 152 and the light pipe support 150 after moving the bearing block 154 towards the surface of the substrate 130.

With reference to embodiments shown in FIG. 3A and FIG. 3B, a transmitted light microscopy system 200 may include a mechanism having a cam 156 and a cam guide 158. Cam 156 may interact with one or more surfaces of cam guide 158 to rotate the cam 156. The cam 156 may be attached to the end of the rotation shaft 152 opposite the light pipe support 150. The cam 156 and the cam guide 158 may be of different shapes and profiles, depending on the desired rotation of the rotation shaft 152. In specific embodiments, the cam 156 may move vertically within a stationary cam guide 158 and interact with one or more surfaces of the cam guide 158 to rotate the cam 156, the rotation shaft 152, and the tapered light pipe 120 about the rotation axis 125. During the use of certain such embodiments, the bearing block 154 may be moved, thereby also moving the rotation shaft 152 and the attached cam 156, causing the cam 156 to interact with the cam guide 158 and rotate the cam 156 and the rotation shaft 152 about the rotation axis 125. In other embodiments, the rotation shaft 152 may be rotated manually, without the interaction of the cam 156 with the cam guide 158.

With reference to FIGS. 3A and 3B, when the large end 122 of the tapered light pipe 120 is positioned to collect light from the lens assembly 104 and the small end 123 is positioned over the substrate 130 to illuminate a sample, the divergence of the cone angle of the output light from the tapered light pipe 120 is increased by the magnification factor of the tapered light pipe 120. Alternately, with reference to FIGS. 4A and 4B, when the small end 123 of the tapered light pipe 120 is positioned to collect light from the lens assembly 104 and the large end 122 is positioned over the substrate 130 to illuminate a sample supported by the substrate 130, the divergence of the cone angle of the output light from the tapered light pipe 120 is decreased by the magnification factor of the tapered light pipe 120.

As shown in FIGS. 3A and 4A, in certain embodiments, the tapered light pipe 120 may be positioned by a motor 162 coupled to the bearing block 154 to move the bearing block 154, the rotation shaft 152, and the light pipe support 150 as desired. The motor 162 may be a servomotor, a stepper motor, a piezo-electric actuator, a solenoid, or the like. With reference to FIGS. 3B and 4B, the light pipe support 150 may rotate the tapered light pipe 120 to a position aligned with the optical axis 116 wherein either the large end 122 or the small end 123 are moved over the substrate 130.

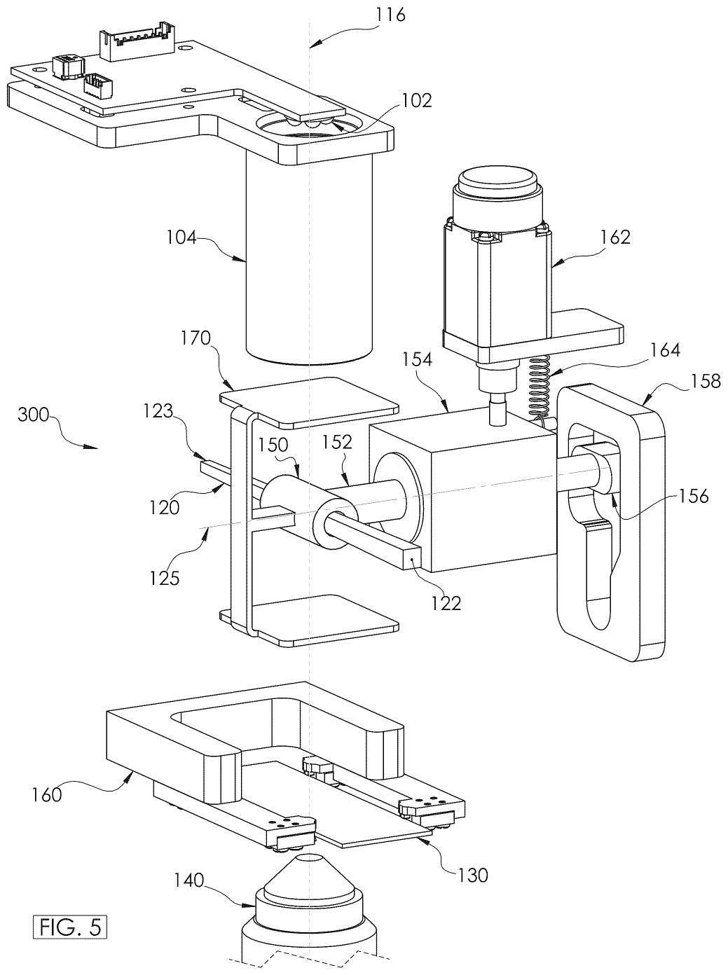

Certain embodiments of a transmitted light microscopy system 300 are described in reference to FIG. 5. The light pipe support 150 may rotate the tapered light pipe 120 to a neutral position on the rotation axis 125 that is not aligned with the optical axis 116, thereby limiting or preventing the tapered light pipe 120 from collecting light from the lens assembly 104. Furthermore, in this position the substrate holder 160 may be free for loading, unloading, translating, and repositioning the substrate 130 without contacting or potentially damaging the tapered light pipe 120. Other embodiments may include a spring 164 configured to raise or retract the bearing block 154 and the tapered light pipe 120 during operation or after shutdown or failure of the motor 162. In further embodiments, a light screen or light shield, such as light blocker 170, may be used to limit or block light from entering the objective lens 140 when the tapered light pipe 120 is in a neutral position.

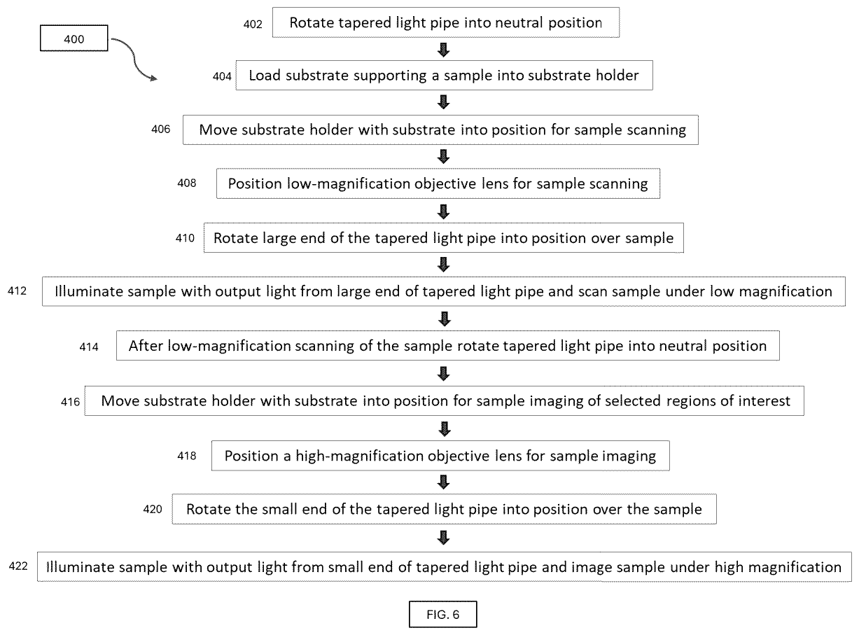

The transmitted light microscopy systems 100 and 200 may be used in various methods of optimizing the cone angle of the sample illuminating light to result in an NA that matches the NA of selected objective lenses. With reference to FIGS. 1, 3A and 4A, such methods may include the use of a mechanism including the rotation shaft 152 configured to rotate the light pipe support 150 and the tapered light pipe 120 to any position on the rotation axis 125, including positions aligned with the optical axis 116, wherein the large end 122 or the small end 123 are positioned to receive light from the light source 102, lens 103, or the lens assembly 104. The mechanism may rotate the tapered light pipe 120 on the rotation axis 125 in a single direction, such as by cycling the mechanism until the desired position is reached. Alternatively, the tapered light pipe 120 may be rotated by the mechanism in either direction on the rotation axis 125 to reach the desired position. Certain such methods, with reference to FIGS. 4A, 4B and 6, may include positioning the small end 123 to receive the light from the lens assembly 104, such that when light enters the tapered light pipe at the small end 123 and then exits from the large end 122 to illuminate a sample supported by the substrate 130, the cone angle of the illumination light is decreased to better match the NA of the selected objective lens 140, such as a low magnification 4× objective lens. Other such methods, with reference to FIGS. 3A, 3B and 6, may include positioning the large end 122 to receive the light from the light source 102, such that when light enters the light pipe at the large end 122 and then exits from the small end 123 to illuminate a sample supported by the substrate 130, the cone angle of the illumination light from the small end 123 is increased to better match the NA of the selected objective lens 140, such as a high magnification 40× objective lens.

Additional methods disclosed herein include methods of positioning a sample for scanning and imaging in a transmitted light microscope. Such methods include the use of the rotatable tapered light pipe 120, allowing the unloading, loading, or positioning of the substrate 130 without contacting or damaging the lens assembly 104 or the tapered light pipe 120. With reference to FIGS. 5 and 6, some methods include rotating the tapered light pipe 120 to a neutral position on the rotation axis 125 that is not aligned with the optical axis 116 and clear of the operation of the substrate holder 160. In some such methods, the objective lens 140 may also be moved clear of the operation of the substrate holder 160. With the tapered light pipe 120 in a neutral position, the substrate holder 160 may be free to move for loading, unloading, translating, and repositioning the substrate 130 without contacting or potentially damaging the tapered light pipe 120. Then, with the substrate holder 160 and the substrate 130 in position for sample scanning and imaging, the disclosed methods may include rotating the tapered light pipe 120 on the rotation axis 125 until aligned with the optical axis 116 to illuminate a sample on the substrate 130.

As shown in FIG. 6, the disclosed methods may include method 400, including steps of rotating the tapered light pipe 120 into the neutral position (step 402) to move the tapered light pipe 120 out of the way while a sample is loaded and positioned for scanning. Next, a substrate 130 supporting a sample may be loaded into the substrate holder 160 (step 404) and then moved into position for sample scanning (step 406). In step 408, a low-magnification objective lens 140 may be selected and positioned for sample scanning. After the substrate holder 160 is in place, the large end 122 of the tapered light pipe 120 may safely be rotated into position over the sample (step 410). The sample may then be illuminated by output light from the large end 122 of the tapered light pipe 120 and scanned under low magnification while looking for regions of interest (step 412). After low-magnification scanning, the light pipe 120 may be rotated out of the way and back into the neutral position (step 414), after which the substrate holder 160 and substrate 130 may be repositioned for high-magnification imaging of selected regions of interest (step 416). Next, a high-magnification objective lens 140 is positioned for sample imaging (step 418) and the small end 123 of the tapered light pipe 120 may then be rotated into position over the sample (step 420). Under illumination from output light from the small end 123 of the tapered light pipe 120, the sample may then be imaged under high magnification (step 422). Some variations of a method may include all steps described in method 400. Some variations of a method include any subset of the steps described in method 400 (e.g., one or more of the steps).

As used herein, the term “light” is not limited to describing electromagnetic radiation in the visible portion of the electromagnetic spectrum but is also intended to describe radiation in the ultraviolet and infrared portions of the electromagnetic spectrum.

The term “sample” is used herein to describe an organic solid, an organic fluid, an inorganic solid, an inorganic fluid, a biological fluid, a biological semi-solid, a biological solid (which may remain solid, such as tissue, or may be liquefied in any appropriate manner), a suspension, a portion of the suspension, a component of the suspension, or the like.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units is also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

What is claimed is:

1. A transmitted light microscopy system comprising:
a light source;
a tapered light pipe comprising a large end and a small end, the large end having a larger surface area than the small end, wherein either the large end or the small end may be positioned to receive light from the light source; and
an objective lens having a numerical aperture and positioned to receive output light from the tapered light pipe,
wherein when the tapered light pipe is positioned to receive the light from the light source and output the light, the output light has a cone angle that results in a numerical aperture that substantially matches the numerical aperture of the objective lens.

2. The system of claim 1, wherein when the large end of the tapered light pipe is positioned to receive the light from the light source, the cone angle of the output light from the small end of the tapered light pipe is increased in comparison to a cone angle of the received light.

3. The system of claim 2, wherein when the large end of the tapered light pipe is positioned to receive the light from the light source, the cone angle of the output light from the small end is increased proportional to the magnification factor of the tapered light pipe.

4. The system of claim 1, wherein when the small end of the tapered light pipe is positioned to receive the light from the light source, the cone angle of the output light from the large end of the tapered light pipe is decreased in comparison to a cone angle of the received light.

5. The system of claim 4, wherein when the small end of the tapered light pipe is positioned to receive the light from the light source, the cone angle of the output light from the large end is decreased proportional to the magnification factor of the tapered light pipe.

6. The system of claim 1, further comprising at least one lens to receive the light from the light source and output the light towards the tapered light pipe.

7. The system of claim 1, further comprising a lens assembly to receive the light from the light source and output the light towards the tapered light pipe.

8. The system of claim 1, further comprising a substrate for supporting a sample.

9. The system of claim 1, further comprising a substrate holder configured to hold a substrate.

10. The system of claim 9, further comprising a mechanism to move the substrate holder and position a sample supported by the substrate to be illuminated by the light output from the tapered light pipe.

11. The system of claim 1, further comprising a mechanism for positioning either the large end or the small end of the tapered light pipe to receive the light from the light source.

12. The system of claim 11, wherein the mechanism is configured to move the tapered light pipe along an optical axis.

13. The system of claim 12, wherein the mechanism comprises at least one spring configured to retract the tapered light pipe.

14. The system of claim 11, wherein the mechanism is configured to rotate the tapered light pipe into at least one position comprising:
a position aligned with the optical axis, wherein the large end of the tapered light pipe is positioned to receive the light from the light source;
a position aligned with the optical axis, wherein the small end of the tapered light pipe is positioned to receive the light from the light source;
a neutral position, wherein the large end and the small end of the tapered light pipe are positioned to prevent receiving light from the light source.

15. The system of claim 14, wherein the mechanism comprises at least one cam and a cam guide.

16. The system of claim 15, wherein the tapered light pipe and the at least one cam are attached to a rotation shaft.

17. The system of claim 11, wherein the mechanism is configured to position the small end of tapered light pipe closer to a substrate than the large end of the tapered light pipe.

18. The system of claim 11, further comprising a light blocker configured to limit light from entering the objective lens.

19. The system of claim 1, wherein the tapered light pipe has a magnification factor of approximately 1.1×, 1.2×, 1.3×, 1.4×, 1.5×, 1.6×, 1.7×, 1.8×, 1.9×, 2.0×, 2.1×, 2.2×, 2.3×, 2.4×, 2.5×, 2.6×, 2.7×, 2.8×, 2.9×, 3.0×, 3.1×, 3.2×, 3.3×, 3.4×, 3.5×, 3.6×, 3.7×, 3.8×, 3.9×, 4.0×, 4.1×, 4.2×, 4.3×, 4.4×, 4.5×, 4.6×, 4.7×, 4.8×, 4.9×, 5.0×, 6.0×, 7.0×, 8.0×, 9.0×, or 10.0×.

20. The system of claim 1, wherein the output light has a cone angle that results in an numerical aperture of approximately 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5% or 100% of the numerical aperture of the objective lens.
